(19) United States
(12) Patent Application Publication
(10) Pub. No.: US 2026/0359355 A1
(43) Pub. Date: Nov. 12, 2026

(54) METHOD, AND APPARATUS FOR VIDEO MATCHING, DEVICE AND PROGRAM PRODUCT

(71) Applicant: Beijing Zitiao Network Technology Co., Ltd., Beijing (CN)

(72) Inventors: Minyang ZHANG, Beijing (CN); Qian LV, Beijing (CN)

(21) Appl. No.: 19/726,654

(22) Filed: Jun. 30, 2026

Related U.S. Application Data
(63) Continuation of application No. PCT/CN2025/088233, filed on Apr. 10, 2025.

(30) Foreign Application Priority Data
May 10, 2024 (CN) 202410578970.3

(51) Int. Cl. G06F 16/783; H04N 21/85

(52) U.S. Cl. CPC G06F 16/7844; H04N 21/85

(57) ABSTRACT

The embodiments of the present disclosure relate to a method and apparatus for video matching, an electronic device and a product. The method comprises: on the basis of an understanding of content of an audio, generating a plurality of segment texts of the audio. The method comprises: on the basis of an understanding of multimodal content of a plurality of videos, generating a plurality of text descriptions for the plurality of videos. In addition, the method further comprises: on the basis of the plurality of segment texts of the audio and the plurality of text descriptions of the plurality of videos, determining a video matching with the at least one of the plurality of segment texts.

The present application is a Continuation of International Patent Application No. PCT/CN2025/088233, filed on Apr. 10, 2025, which claims priority to Chinese Patent Application No. 202410578970.3, filed on May 10, 2024, and entitled “METHOD AND APPARATUS FOR MATCHING VIDEO, DEVICE, AND PROGRAM PRODUCT”, which is incorporated herein by reference in its entirety.

### FIELD

The present disclosure generally relates to the field of computers, and more particularly, to a method, an apparatus, an electronic device, and a product for matching video material.

### BACKGROUND

Video editing refers to the process of performing post-processing such as selection, cutting, and concatenating on obtained original video material in order to optimize content, adjust rhythm, enhance expressiveness, etc., and finally form a coherent and complete video work in the video production process.

Selecting original video material is a key step in the video editing process, which directly determines the quality and style of the final video work. This process involves reviewing and analyzing a large amount of material to ensure that the selected material may best serve the theme and narrative needs of the video. Adding audio to selected video materials for matching is also a crucial step in the video editing process. This step aims to ensure that the video and audio are coordinated in terms of content and rhythm, thereby improving the quality and viewing experience of the entire video work.

### SUMMARY

Embodiments of the present disclosure provide a method, an apparatus, an electronic device, and a product for matching video material.

According to a first aspect of the present disclosure, there is provided a method for matching video material. The method includes generating, based on understanding of content of an audio, a plurality of segment texts of the audio. The method includes generating, based on understanding of multimodal content of a plurality of video materials, a plurality of text descriptions of the plurality of video materials. In addition, the method further includes determining, based on the plurality of segment texts of the audio and the plurality of text descriptions of the plurality of video materials, a video material matching with each of the plurality of segment texts.

In a second aspect of the present disclosure, there is provided an apparatus for matching video material. The apparatus includes a segment text generation module configured to generate, based on understanding of content of an audio, a plurality of segment texts of the audio. The apparatus further includes a text description generation module configured to generate, based on understanding of multimodal content of a plurality of video materials, a plurality of text descriptions of the plurality of video materials. In addition, the apparatus further includes a video material determination module configured to determine, based on the plurality of segment texts of the audio and the plurality of text descriptions of the plurality of video materials, a video material matching with each of the plurality of segment texts.

In a third aspect of the present disclosure, there is provided an electronic device. The electronic device includes a processor and a memory coupled with the processor, the memory having instructions stored therein, the instructions, when executed by the processor, causing the electronic device to perform the method according to the first aspect.

In a fourth aspect of the present disclosure, there is provided a computer program product having stored thereon computer-executable instructions, where the computer-executable instructions are executed by a processor to implement the method of the first aspect.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The above and other features, advantages, and aspects of the embodiments of the present disclosure will become more apparent in combination with the drawings and with reference to the following detailed description. In the drawings, the same or similar reference numbers refer to the same or similar elements, where:

FIG. 1 shows a schematic diagram of an example environment in which some embodiments of the present disclosure may be implemented;

FIG. 2 shows a flowchart of a method for matching video material according to some embodiments of the present disclosure;

FIG. 3 shows a schematic diagram of a process of matching an audio with video material according to some embodiments of the present disclosure;

FIG. 4A shows a schematic diagram of importing an audio according to some embodiments of the present disclosure;

FIG. 4B shows a schematic diagram of displaying an imported audio on an audio track according to some embodiments of the present disclosure;

FIG. 4C shows a schematic diagram of importing video material according to some embodiments of the present disclosure;

FIG. 5 shows a schematic diagram of types of matching between an audio and video material according to some embodiments of the present disclosure;

FIG. 6A shows a schematic diagram of an effect of matching audio narration content with video lines according to some embodiments of the present disclosure;

FIG. 6B shows a schematic diagram of another effect of matching audio narration content with video lines according to some embodiments of the present disclosure;

FIG. 6C shows a schematic diagram of an effect of matching audio narration content with a video image according to some embodiments of the present disclosure;

FIG. 6D shows a schematic diagram of another effect of matching audio narration content with a video image according to some embodiments of the present disclosure;

FIG. 6E shows a schematic diagram of an effect of matching audio narration content with a video image and lines according to some embodiments of the present disclosure;

FIG. 7 shows a block diagram of an apparatus for matching video material according to some embodiments of the present disclosure; and

FIG. 8 shows a block diagram of an electronic device according to some embodiments of the present disclosure.

Throughout the drawings, the same or similar reference numbers refer to the same or similar elements.

### DETAILED DESCRIPTION OF EMBODIMENTS

It may be understood that the data involved in the technical solution (including but not limited to the data itself, acquisition or use of the data) shall comply with requirements of corresponding laws, regulations, and related provisions.

It may be understood that before using the technical solutions disclosed in the embodiments of the present disclosure, the user shall be informed of the type, range of use, use scenarios, etc., of personal information involved in the present disclosure and the authorization of the user shall be obtained in an appropriate manner in accordance with relevant laws and regulations.

For example, when receiving an active request from a user, prompt information is sent to the user to clearly prompt the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select “agree” or “disagree” to provide the personal information to the electronic device.

It may be understood that the above process of notifying and obtaining user authorization is only illustrative and does not limit the implementations of the present disclosure, and other methods that satisfy the relevant laws and regulations may also be applied in the implementations of the present disclosure.

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein; rather, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The terms “first”, “second”, etc. may refer to different or same objects, unless explicitly stated. Other explicit and implicit definitions may also be included below.

At present, when editing a video work, a user needs to search for video material related to an imported audio one by one, which brings inconvenience to the user when contributing the video work. Searching for video material matching with the audio one by one will consume a lot of time and energy. Especially when the audio and the video material are complex and long, not only the period of video production is extended, but also the creative enthusiasm and motivation of the user may be affected. Secondly, matching precision is difficult to guarantee. Manually searching for and matching the video material one by one is prone to inaccurate matching or omission due to human factors. Such inaccurate matching may affect the overall quality and viewing experience of the video work, and may even change the content that is originally intended to be conveyed.

According to the embodiments of the present disclosure, a plurality of segment texts accurately reflecting core content of corresponding parts in an audio may be generated through understanding of audio content. Meanwhile, through processing of multimodal content (such as images, sound, and subtitles) of a plurality of video materials, key content may be extracted from the video materials, and corresponding text descriptions may be generated, which can reduce the time for video producers to manually write and sort out the audio and the material, and improve the efficiency of video production. After the generation of the audio segment texts and the text descriptions of the video materials is completed, the next step is to compare and analyze each segment text of the audio with the text descriptions of the video materials, so that the video material best matching with each audio segment text may be automatically determined, which facilitates the video producers to complete a large amount of material filtering and matching work in a short time.

Through this method, complex operations required in the processes of material searching, placing, editing, etc. by video editors can be reduced, thereby improving the efficiency of material matching. This not only reduces production costs, but also improves the quality and viewing experience of video works, bringing a better visual experience for audiences, and thus improving the experience of users of all parties.

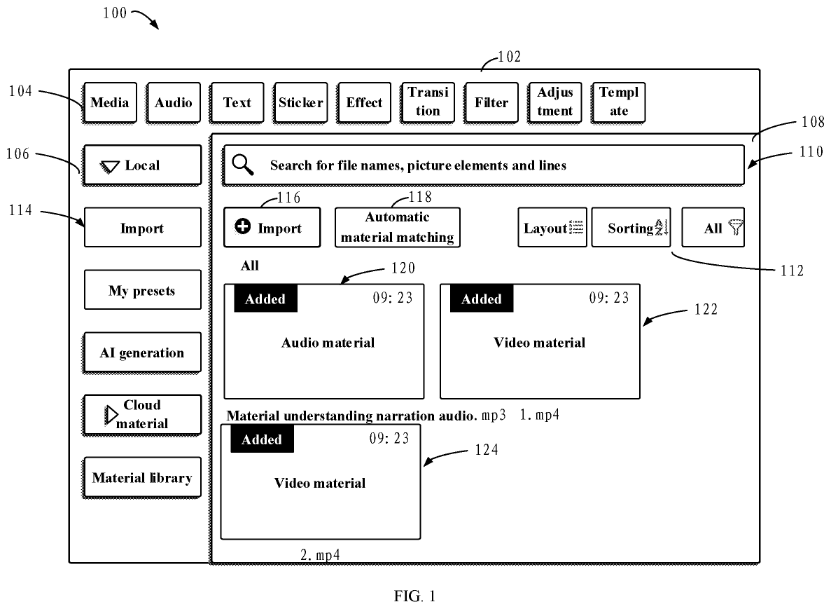

FIG. 1 shows a schematic diagram of an example environment 100 in which some embodiments of the present disclosure may be implemented. As shown in FIG. 1, an interface 102 may be an interface for a user to import an audio 120, a video material 122, and a video material 124. The interface 102 may include a menu bar 104, which includes a plurality of options such as “media”, “audio”, “text”, and “sticker”, and these options can provide the user with a variety of editing functions and operation possibilities. On the left side of the interface 102, there may be a material import area 106, which includes a plurality of primary options such as “local”, “cloud material”, and “material library”.

The “cloud material” option can allow the user to access and import material from cloud storage conveniently. In the process of video editing, the user may use the material stored in the cloud, instead of importing from a local device every time. The “material library” option allows the user to browse and select more material segments from the material library. The “local” option in the material import area 106 allows the user to import material such as video, audio, and images from a local storage device (such as a hard disk) of the user's computer into the editing software. In this way, the user can add various media files saved locally to an editing project for subsequent editing, concatenating, effect adding, and other operations.

The center part of the interface 102 is a display area 108 of material that has been imported by the user. Above the material display area 108 is a search box 110, in which the user may quickly locate required material by entering a file name, picture elements, or lines. At the lower right of the search box 110 is a view editing area 112, which includes options such as “layout”, “sorting”, and “filtering”. The user may use the view editing area 112 to select to display imported material segments. If the user switches to an “import” view 114, in the material display area 108, a material file required for an editing project may be imported through an “import” button 116. For example, when the user clicks on the “import” button 116, a file selection dialog box may pop up, allowing the user to browse and select a local file. After the required files are selected, these files will be imported into the material library of the editing software and become material available for editing.

In the material display area 108, the imported audio 120, the imported video material 122, and the imported video material 124 are displayed. Each material segment has a respective thumbnail and playing time marker. These material segments may be selected from the material library imported by the user, and the user may select and add them to an editing sequence as needed. File name and duration information is displayed below the thumbnail of each material segment, which is convenient for the user to identify and manage. When the user wants to quickly find, in the imported video material 122 and the imported video material 124, video material that matches with the imported audio 120, appropriate material for the audio may be found through “automatic material matching” 118. The interface 102 shows a video editing software interface with comprehensive functions and convenient operation, through which both beginners and professional editors can perform material management and editing work.

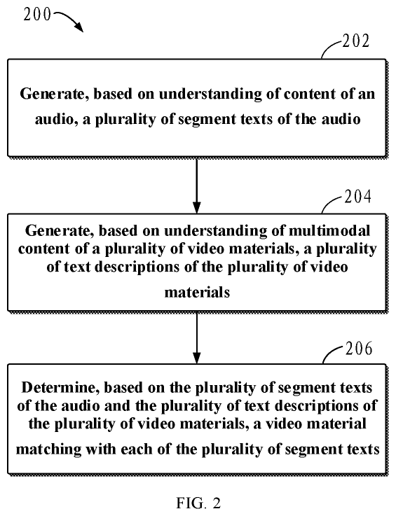

The process according to the embodiments of the present disclosure will be described in detail below with reference to FIG. 2 to FIG. 8. For ease of understanding, the specific data mentioned in the following description is exemplary and is not used to limit the protection scope of the present disclosure. It may be understood that the embodiments described below may further include additional actions not shown and/or may omit the actions shown, and the scope of the present disclosure is not limited in this regard.

FIG. 2 shows a flowchart of a method 200 for matching video material according to some embodiments of the present disclosure. At a block 202, a plurality of segment texts of an audio are generated based on understanding of content of the audio. In some embodiments, the audio may be a narration audio recorded by a user. In some embodiments, it is assumed that there is an audio with content as follows: “This video shows a busy city street scene. Many pedestrians and vehicles may be seen in the video, shuttling back and forth on the street. High-rise buildings line both sides of the street, creating a modern urban atmosphere. Meanwhile, the words on the billboard also attract people's attention.” After understanding of the above audio content, a plurality of segment texts may be generated: segment text 1 “this video shows a busy city street scene”; segment text 2 “many pedestrians and vehicles may be seen in the video, shuttling back and forth on the street”; segment text 3 “high-rise buildings line both sides of the street, creating a modern urban atmosphere”; and segment text 4 “the words on the billboard also attract people's attention”. Each segment text understands a part of key content in the audio, and maintains the coherence and integrity of the content. Such segment texts not only help to better understand and analyze the audio content, but also provide convenience for subsequent audio-video matching.

At a block 204, a plurality of text descriptions of a plurality of video materials are generated based on understanding of multimodal content of the plurality of video materials. It is assumed that there is a video material about city life, and the video sequentially includes pedestrians, vehicles, buildings, billboards, conversations between people, and the like on a street, and the video may be clipped into several video material segments in sequence. In some embodiments, a conversation of the pedestrians in the video may be converted into a text form, for example, “what a busy place, with people coming and going”. In some embodiments, image content in the video may be analyzed to generate a text expression such as “the video shows many pedestrians and vehicles, and high-rise buildings line both sides of the street”. In some embodiments, text information in the video may be recognized. If there is text on a billboard or a shop sign in the video, for example, it may be converted into an editable text, for example, “the billboard says ‘welcome’”. In some embodiments, the above content may also be synthesized to generate the following description of video content: “this video successfully captures the busyness and colorfulness of city life”. This method helps to understand the content and characteristics of the video material more comprehensively, and provides strong support for subsequent video processing and applications.

At a block 206, a video material matching with each of the plurality of segment texts is determined based on the plurality of segment texts of the audio and the plurality of text descriptions of the plurality of video materials. In some embodiments, the segment text 3 “high-rise buildings line both sides of the street, creating a modern urban atmosphere” may be matched with the text description “the video shows many pedestrians and vehicles, and high-rise buildings line both sides of the street” generated from the video, so that a respective segment of the video material is used as the video material matching with the audio segment text 3. Similarly, other segment texts such as the segment text 1 may also be matched with the generated text description of the video content to find the most suitable video material.

In the embodiments of the present disclosure, through the manner of generating a plurality of segment texts based on understanding of audio content, the audio content can be structured, which facilitates subsequent matching of video material. Meanwhile, analyzing the multimodal content of the video material may enable more comprehensive extraction of the content of the video material, ensuring the accuracy and richness of the text description, and the manner of comprehensively extracting the content of the video material also facilitates subsequent matching with the audio segment text. Further, by comparing the segment text of the audio with the text expression of the video material, accurate synchronization and correspondence between audio and video can be achieved, and this method also improves the efficiency of video production, thereby enhancing the user experience.

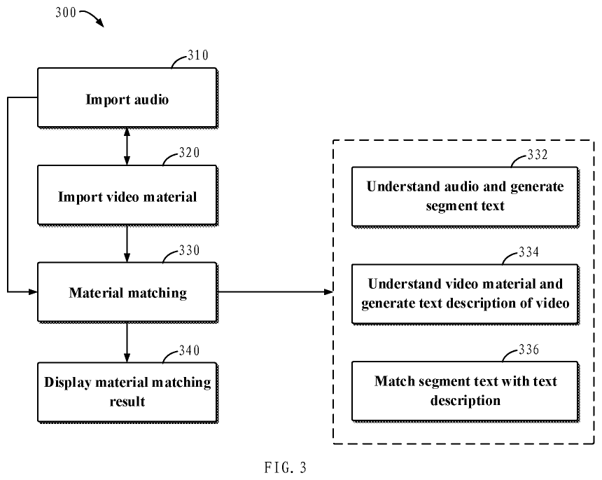

FIG. 3 shows a schematic diagram of a process 300 of matching an audio with video material according to some embodiments of the present disclosure. Referring to FIG. 3, at 310, an audio is imported, which may include background music, sound effects, human voice dialogue, natural sounds, voice narration audio, and the like. The system supports various audio formats, for example, the audio may be in the WAV format, the MP3 format, the AAC format, the WMA format or other formats. This increases flexibility and compatibility, and enables the user to process different types of material more conveniently.

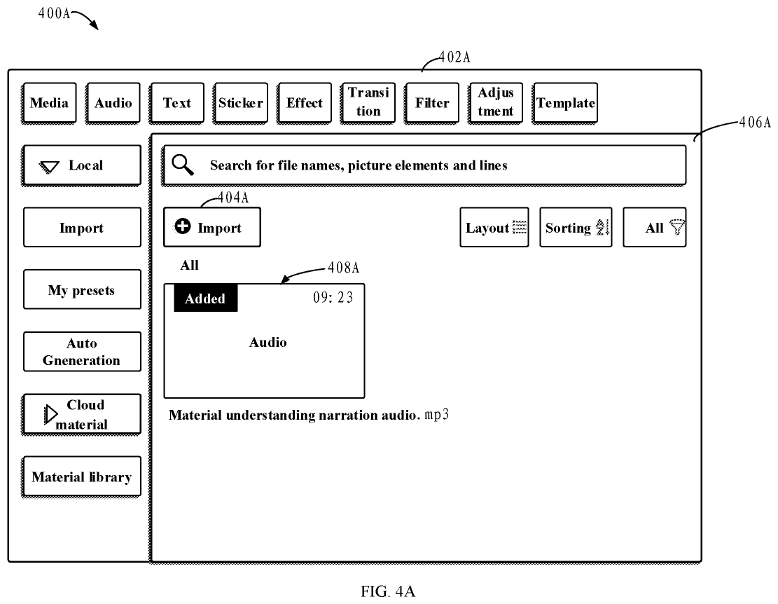

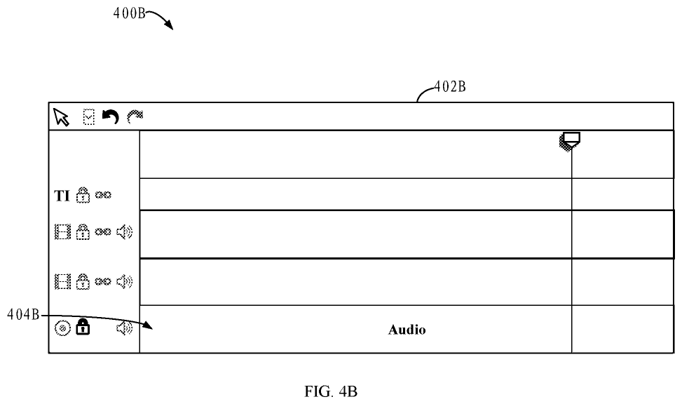

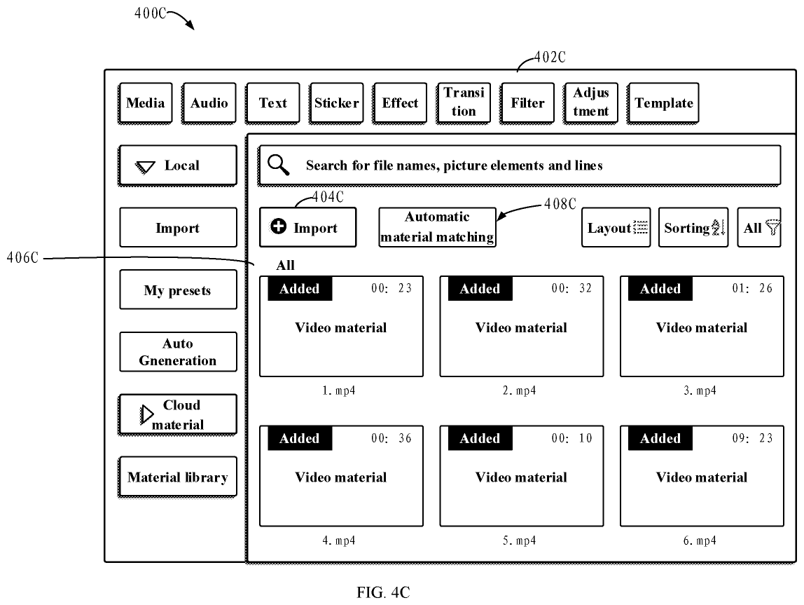

The following will illustrate, with reference to FIG. 4A-4B, a schematic diagram of importing an audio according to some embodiments of the present disclosure and a schematic diagram of displaying an imported audio on an audio track according to some embodiments of the present disclosure. FIG. 4A shows a schematic diagram of importing an audio 400A according to some embodiments of the present disclosure. FIG. 4A shows the importing audio shown at 310 in FIG. 3. Referring to FIG. 4A, in an interface 402A, a user may import an audio material 408A that the user needs to use through an “import” button 404A in a material display page 406A. FIG. 4B shows a schematic diagram of displaying an imported audio 400B on an audio track according to some embodiments of the present disclosure. As shown in FIG. 4B, the audio imported by the user is on an audio track 404B at the bottom of a track editing page 402B.

Returning to FIG. 3, at 320, video material is imported, which may include an actual scene shot, animation, an effect segment, or a completed film segment, etc. The following will illustrate, with reference to FIG. 4C, a schematic diagram of importing video material according to some embodiments of the present disclosure. FIG. 4C shows a schematic diagram of importing video material 400C according to some embodiments of the present disclosure. FIG. 4C shows the importing video material shown at 320 in FIG. 3. Referring to FIG. 4C, in an interface 402C, after importing an audio that the user needs to use, the user may continue to import video material 406C that the user needs to use through an “import” button 404C. There is no sequence between importing the audio and importing the video materials. After different types of files are imported into a video editing project, “automatic material matching” 408C may appear. With reference to FIG. 3, material matching 330 shown in FIG. 3 may then be performed through the “automatic material matching” 408C.

By importing material through a direct click on a button, the user may import the material without using a complex menu or performing complex steps, which simplifies the operation process, improves the operation efficiency, and makes the material import more intuitive and simple. The user-friendly design reduces confusion and frustration that the user may encounter during operation, and improves the overall user experience.

Continuing to refer to FIG. 3, at 330, material matching is performed. For example, in a narration video editing project, when a user has imported an audio and some video material for matching with the audio, the most suitable video material for the imported narration audio may be automatically searched for. Specifically, at 332, the audio is understood and a segment text is generated. In some embodiments, the content of the narration audio uploaded by the user may be deeply understood through a big Automatic Speech Recognition (Big ASR) model, and a plurality of segment texts may be generated. For example, for the following audio “In middle age, the protagonist runs a physical store independently, takes care of goods in the store daily, negotiates the store renewal plan with the landlord, and takes proper rest during leisure time”, the following texts may be automatically generated through the big Automatic Speech Recognition model: segment text 1 “Running a physical store independently in middle age”; segment text 2 “Tending to goods in the store on a daily basis”; segment text 3 “Daily operation scene of the store”; segment text 4 “Negotiating the renewal plan for the store”; and segment text 5 “Taking proper rest during leisure hours” . In this way, the user can be assisted in avoiding manually segmenting audio text content into a plurality of small segments, thereby improving the work efficiency of the user and enhancing the user experience.

At 334, the video material is understood and a text description of the video is generated. In some embodiments, the text description of the video material may be generated through a multimodal understanding model. In some embodiments, the multimodal understanding model has at least multimodal capabilities of a big Automatic Speech Voice model, computer vision (CV), optical character recognition (OCR), highlight segment, etc. The highlight segment capability refers to the capability of automatically recognizing, extracting, and presenting the most excellent and eye-catching segments in video, audio, or other multimedia content. These highlight segments are usually the most representative and attractive parts of the content. In some embodiments, the segment text description of the video material includes lines of the video material, a description of images of the video material, and a combined description of the lines and the images of the video material. Through this adaptive and flexible method for understanding video content in a multimodal manner, a more accurate text description of the video material can be generated.

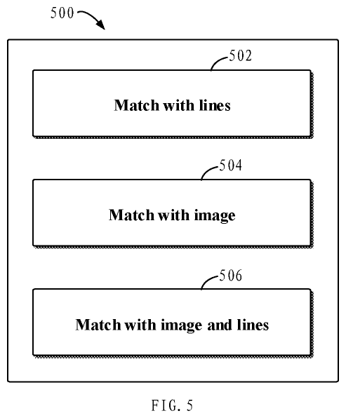

The following will illustrate types of matching between an audio and video material according to some embodiments of the present disclosure with reference to FIG. 5. FIG. 5 shows a schematic diagram of types 500 of matching between an audio and video material according to some embodiments of the present disclosure. FIG. 5 shows the types of matching the segment text with the video text description shown at 334 in FIG. 3. Referring to FIG. 5, at 502, match with lines. If the lines in the video material are relatively dominant, the text description of the video may be generated according to the lines in the video material. Thus, the matching degree between the text description including the video lines and the segment text may be calculated. In some embodiments, if a subtitle of the line “Negotiate the store's plan” in the video is dominant in the multimodal content of the video, it may be generated, through the multimodal understanding model, that the text description of the video material is “The store owner discusses arrangements for his store”.

Referring to FIG. 5, at 504, matching with an image. If the image in the video material is relatively dominant, the text description of the video may be generated according to the image in the video material. Thus, the matching degree between the text description including the video content and the segment text may be calculated. In some embodiments, if an image of “white-haired elder” in the video material is dominant in the multimodal content, that is, if there is only an image, it may be generated through the multimodal understanding model that the text description of the video material is “Children visit their elder family member”.

Referring to FIG. 5, at 506, matching with an image and lines. If both the lines and the image in the video material are dominant, the text description of the video may be generated according to the lines and the image in the video material. Thus, the matching degree between the text description including the video content and the segment text may be calculated. In some embodiments, if both the line “Let's discuss our differences in operation” and the image “Two parties communicate about store planning” in the video material are dominant, it may be generated, through the multimodal understanding model, that the text description of the video material is “Two people negotiate business operation plans”.

In some embodiments, for such video material “The store owner stands at the entrance of his self-operated health supplies store and calmly checks the exterior of the store. At this moment, the store owner receives a phone call from the landlord regarding the store”, the image and sound of the store owner standing at the store entrance may be recognized through the multimodal understanding model, and a text description “The store owner communicates with the landlord about matters related to store” may be generated.

In some embodiments, the signboard of the owner's store may be recognized through the multimodal understanding model, and a text description “Daily operation scene of a store” may be generated. In some embodiments, the owner's posture, and environmental features in the store may also be recognized through the multimodal understanding model, and content description “The store owner carefully deliberates on matters related to store planning” may be generated. In some embodiments, these content descriptions may be combined to finally generate content description “Negotiate planning for store”.

Returning to FIG. 3, after the plurality of segment texts of the audio and the plurality of text descriptions of the plurality of video materials are generated, at 336, the segment texts are matched with the text descriptions. In some embodiments, the matching degree between each segment text of the audio and the plurality of text descriptions of the plurality of video materials uploaded by the user may be calculated. In some embodiments, the target video material to be matched is determined according to the level of the matching degree.

In some embodiments, one of the segment texts of the audio is “Negotiating matters regarding store”, and in the text descriptions of the plurality of videos, it is calculated that the matching degree between the text description “Let's communicate about the store arrangements” of the video material 1 and the segment text “Negotiating matters regarding store” is 95%, and this matching degree is the highest among the matching degrees with numerous video materials, then the first video material best matching with the segment text “unable to pay the rent” is the video material 1.

In some embodiments, the text description “Negotiating matters regarding store” of the video material 1 may be determined according to the lines of the video material 1, or may be determined according to the image of the video material 1, or may also be determined according to the image and the lines of the video material 1.

In some embodiments, if the video material 2 is best matching with both the segment text 1 and the segment text 2, it may be determined, according to the chronological order of the segment text 1 and the segment text 2 in the audio, which segment text the video material 2 is the matching template video material of. For example, if the segment text 1 is before the segment text 2, the segment text best matching with the video material 2 is the segment text 1. In some embodiments, a video material less matching with the segment text 2 than the video material 2 may be selected to match with the segment text 2.

In some embodiments, if the duration of the video material 1 is longer than that of the segment text “Negotiating matters regarding store”, a segment of candidate video material 1 best matching with the segment text “Negotiating matters regarding store” may be determined from the video material 1 through the multimodal understanding model according to the duration of the segment text “Negotiating matters regarding store”. For example, it may be determined that a highlight segment in the video material 1 with the same duration as the segment text “Negotiating matters regarding store” is the segment of candidate video material best matching with the segment text. In some embodiments, if the duration of the video material 1 is shorter than that of the segment text “Negotiating matters regarding store”, a video material with a second highest matching degree (for example, the matching degree of the video material 2 is 90%) may be selected according to the matching degree to fill in.

Continuing to refer to FIG. 3, at 340, a material matching result is displayed for a user. For example, in the narration video editing project, the video material matching with the audio uploaded by the user and the time of the respective video material may be displayed to the user, the matching degree between the segment text and the respective video material may also be displayed to the user, or a brief summary of the video material may also be displayed to the user.

Through the matching between the segment titles of the narration audio and the descriptions of the material content, the most suitable video material can be automatically found to fill each narration. This method of precise matching reduces complex operations such as material searching, placing, and editing, makes the video production process more concise and efficient, and reduces the difficulty of production, and is more user-friendly especially for beginners or non-professional producers, thereby improving user experience. Meanwhile, the matching degree between the video material and the audio segment text is displayed to the user, and the user may choose to keep, replace, or further optimize the audio material by viewing the matching degree score, so as to ensure an optimal coordination effect between the final video content and the narration audio. This flexible adjustment mechanism not only improves the production personalization level, but also further ensures the quality of the video work and the audience viewing experience.

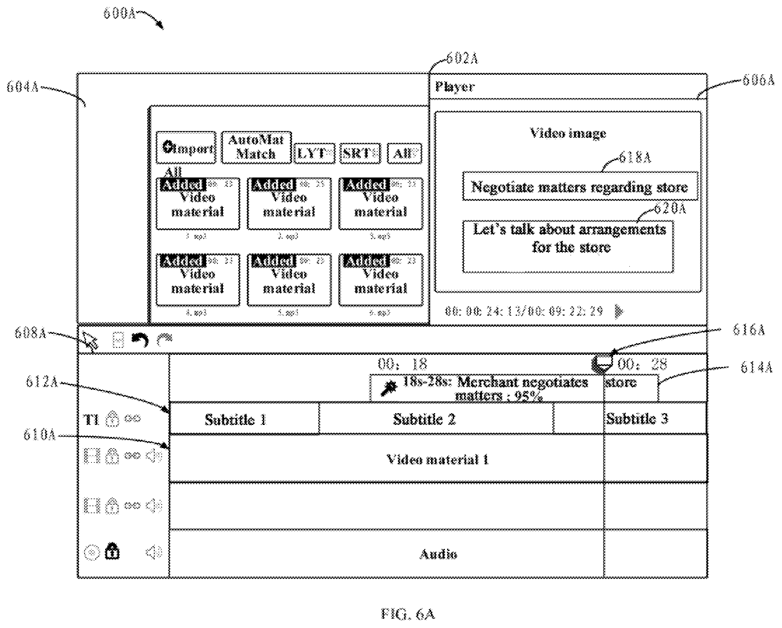

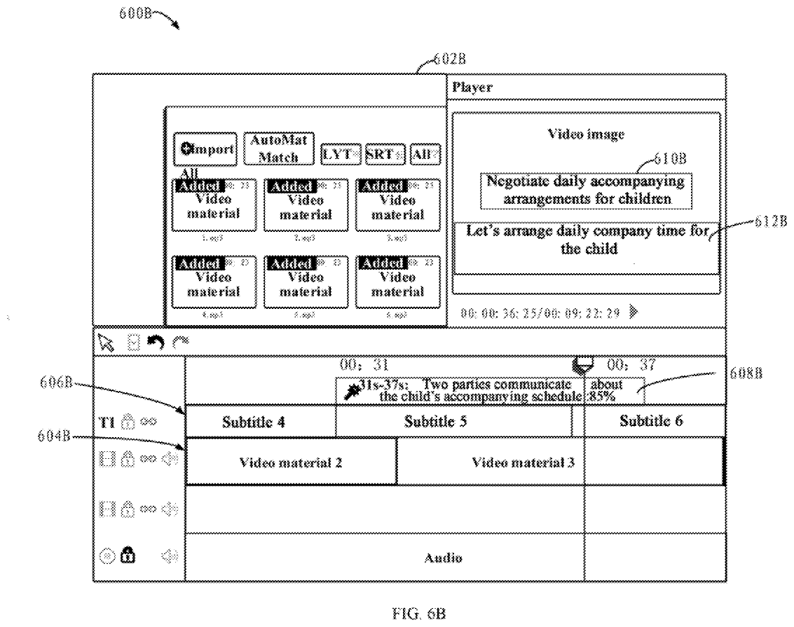

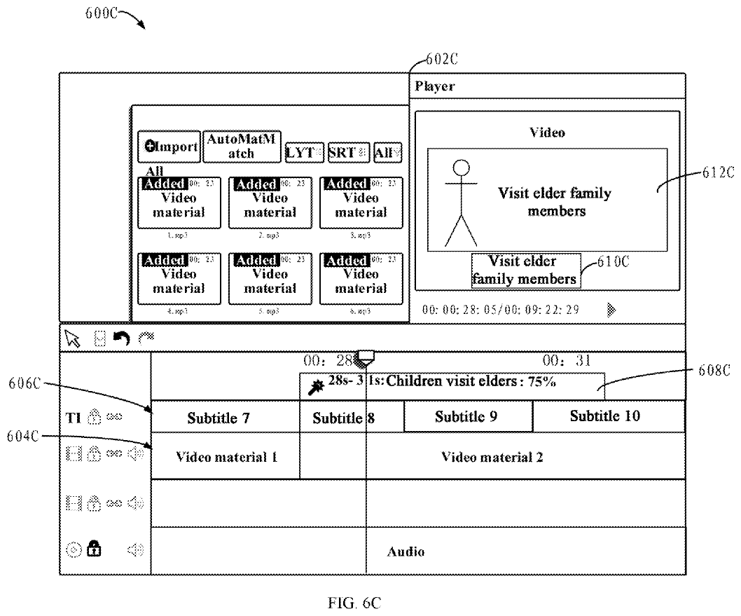

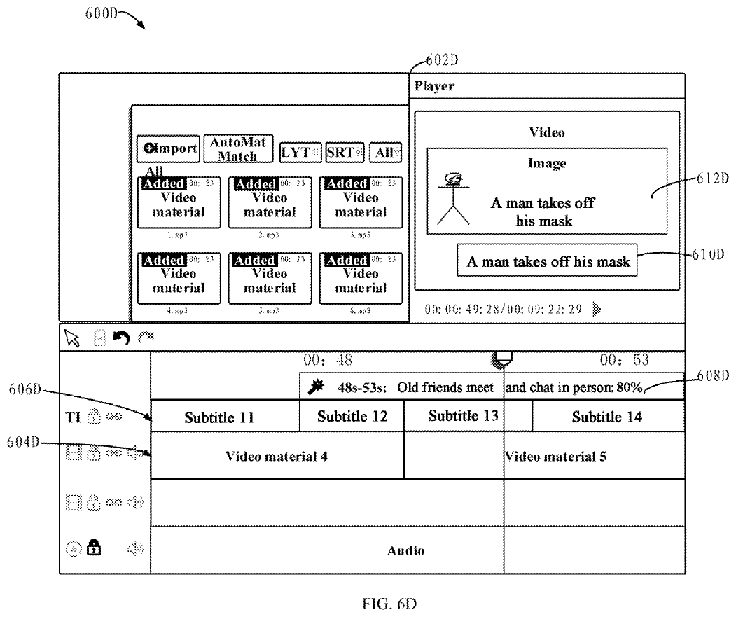

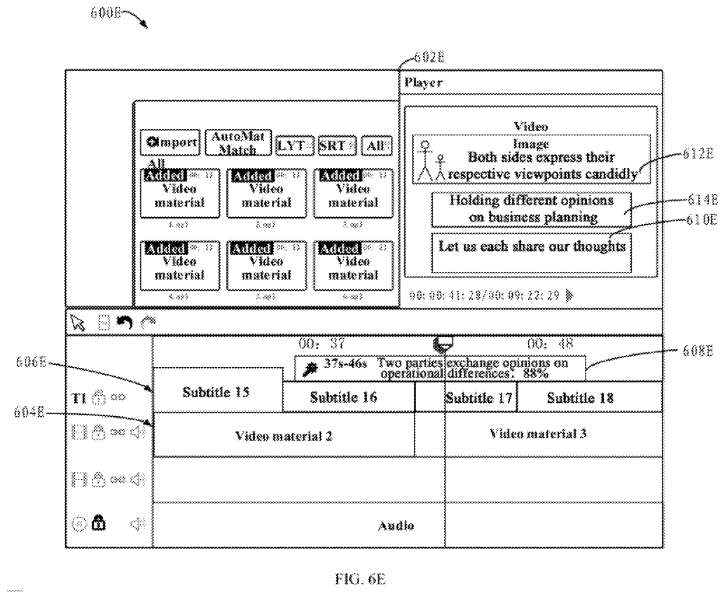

The following will illustrate the display effect of the matching between the audio and the video material with reference to FIG. 6A-6E. FIG. 6A shows a schematic diagram of an effect 600A of matching an audio segment text with video lines according to some embodiments of the present disclosure. FIG. 6A shows the matching between the audio content and the lines shown at 502 in FIG. 5. Combining with FIG. 4C, when a user imports material understanding narration audio and respective video materials into a video editing project and clicks on the “automatic material matching” 408C, the interface 602A shown in FIG. 6A may appear. Referring to FIG. 6A, the interface 602A includes a material import page 604A, a player page 606A, and a track editing page 608A. The material import page 604A shown in FIG. 6A is the interface 402A in FIG. 4A or the interface 402C in FIG. 4C. The track editing page 608A includes editing areas such as a main video track area 610A, a subtitle track area 612A, a matching result display area 614A, and a timeline pointer 616A. The main video track area 610A is used for placing and editing video material. In the subtitle area 612A, the segment text content of the material understanding narration audio is displayed. In the matching result display area 614A, information such as a summary of the video material corresponding to the audio content, the duration of the video material, and the matching degree may be displayed.

Continuing to refer to FIG. 6A, in combination with 332 shown in FIG. 3, it may be obtained that a segment text of a section of audio of the material understanding narration audio is “Negotiate matters regarding store”, and after the material matching 330 shown in FIG. 3, the video material 1 corresponding to the segment text “Negotiate matters regarding store” of the audio content is displayed on the video track 610A of the track editing page 608A. When the timeline pointer 616A stays in the respective area, in the video image on the player page 606A, it may be seen that the line 620A “Let's talk about arrangements for the store” in the video material 1 is displayed, and the corresponding segment text subtitle 618A “Negotiate matters regarding store” is also displayed in the video. At this point, referring to the information displayed in the matching result display area 614A, it may be seen that the main content of the 18 s-28 s in the video material 1 is “Merchant negotiates store matters”, and the matching degree with the segment text “Negotiate matters regarding store” is 95%.

FIG. 6B shows a schematic diagram of another effect 600B of matching an audio segment text with video lines according to some embodiments of the present disclosure. FIG. 6B shows the matching between the audio content and the lines shown at 502 in FIG. 5. Combining with FIG. 4C, when a user imports material understanding narration audio and respective video materials into a video editing project and clicks on the “automatic material matching” 408C, the interface 602B shown in FIG. 6B may appear. Referring to FIG. 6B, in combination with 332 shown in FIG. 3, the text content of the material understanding narration audio may be obtained in the subtitle area 606B. For example, a segment text of a section of audio is “Negotiate daily accompanying arrangements for children”, and after the material matching 330 shown in FIG. 3, the video material 3 corresponding to the segment text “Negotiate daily accompanying arrangements for children” of the audio content is displayed on the video track 604B. When the timeline pointer stays in the respective area, in the video image on the player page, it may be seen that the line 612B “Let's arrange daily company time for the child” in the video material 3 is displayed, and the corresponding segment text subtitle 610B “Negotiate daily accompanying arrangements for children” is also displayed in the video. At this point, referring to the information displayed in the matching result display area 608B, it may be seen that the main content of the 31 s-37 s in the video material 3 is “Two parties communicate about the child's accompanying schedule”, and the matching degree with the segment text “Negotiate daily accompanying arrangements for children” is 85%.

FIG. 6C shows a schematic diagram of an effect 600C of matching an audio segment text with a video image according to some embodiments of the present disclosure. FIG. 600C shows the matching between the audio content and the image shown at 504 in FIG. 5. Combing with FIG. 4C, when a user imports material understanding narration audio and respective video material into a video editing project and clicks on the “automatic material matching” 408C, the interface 602C shown in FIG. 6C may appear. Referring to FIG. 6C, in combination with 332 shown in FIG. 3, the text content of the material understanding narration audio may be obtained in the subtitle area 606C. For example, a segment text of a section of audio is “Visit elder family members”, and after the material matching 330 shown in FIG. 3, the video material 2 corresponding to the segment text “Visit elder family members” of the audio content is displayed on the video track 604C. When the timeline pointer stays in the respective area, in the video image on the player page, it may be seen that the image 612C in the video material 2 is an image of “Visit elder family members”, and the corresponding segment text subtitle 610C “Visit elder family members” is also displayed in the video. At this point, referring to the information displayed in the matching result display area 608C, it may be seen that the main content of the 28 s-31 s in the video material 2 is “Children visit elders” , and the matching degree with the segment text “Visit elder family members” is 75%.

FIG. 6D shows a schematic diagram of another effect 600D of matching an audio segment text with a video image according to some embodiments of the present disclosure. FIG. 6D shows the matching between the audio content and the image shown at 504 in FIG. 5. With reference to FIG. 4C, when a user imports material understanding narration audio and corresponding video material into a video clipping project and clicks on the “automatic material matching” 408C, the interface 602D shown in FIG. 6D may appear. Referring to FIG. 6D, in combination with 332 shown in FIG. 3, the text content of the material understanding narration audio may be obtained in the subtitle area 606D. For example, a segment text of a section of audio is “A man takes off his mask”, and after the material matching 330 shown in FIG. 3, the video material 5 corresponding to the segment text “A man takes off his mask” of the audio content is displayed on the video track 604D. When the timeline pointer stays in the respective area, in the video image on the player page, it may be seen that the image 612D in the video material 5 is an image of “A man takes off his mask”, and the corresponding segment text subtitle 610D “A man takes off his mask” is also displayed in the video. At this point, referring to the information displayed in the matching result display area 608D, it may be seen that the main content of the 48 s-53 s of the content in the video material 5 is “Long-separated old friends meet and chat in person”, and the matching degree with the segment text “A man takes off his mask” is 85%.

FIG. 6E shows a schematic diagram of an effect 600E of matching an audio segment text with a video image and lines according to some embodiments of the present disclosure. FIG. 6E shows the matching between the audio content and the image and lines shown at 506 in FIG. 5. Combining with FIG. 4C, when a user imports material understanding narration audio and respective video materials into a video editing project and clicks on the “automatic material matching” 408C, the interface 602E shown in FIG. 6E may appear. Referring to FIG. 6E, in combination with 332 shown in FIG. 3, the text content of the material understanding narration audio may be obtained in the subtitle area 606E. For example, a segment text of a section of audio is “Holding different opinions on business planning”, and after the material matching 330 shown in FIG. 3, the video material 3 corresponding to the segment text “Holding different opinions on business planning” of the audio content is displayed on the video track 604E. When the timeline pointer stays in the corresponding area, in the video image on the player page, it may be seen that the image 612E in the video material 3 is an image of “Both sides express their respective viewpoints candidly” and the line 610E “Let us each share our thoughts” is displayed, and the corresponding segment text subtitle 614E “Holding different opinions on business planning” is also displayed in the video. At this point, referring to the information displayed in the matching result display area 608E, it may be seen that the main content of the 37 s-48 s of the content in the video material 3 is “Two parties exchange opinions on operational differences”, and the matching degree with the segment text “Holding different opinions on business planning” is 88%.

This method of automatically generating and displaying the content description of the video material and the segment text on the track boundary page reduces the time for video producers to manually write and sort out, and enables the video producers to focus more on the creation and optimization of video content, thereby improving the overall production efficiency. Meanwhile, the generated description and title can more accurately reflect the core content of the video material and the narration audio, and the displayed matching degree may facilitate the user to decide whether to adjust the edited video material.

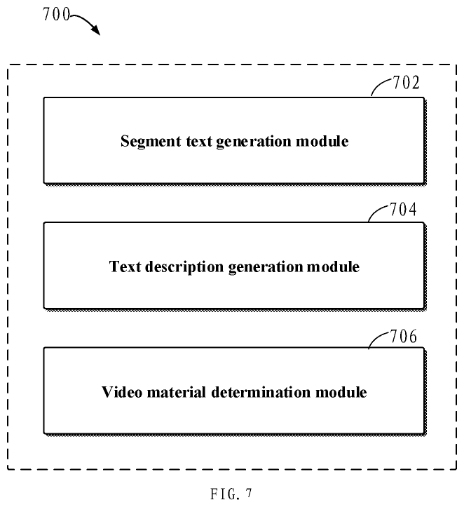

FIG. 7 shows a block diagram of an apparatus 700 for matching video material according to some embodiments of the present disclosure. As shown in FIG. 7, the apparatus 700 includes a segment text generation module 702 configured to generate, based on understanding of content of an audio, a plurality of segment texts of the audio. The apparatus 700 further includes a text description generation module 704 configured to generate, based on understanding of multimodal content of a plurality of video materials, a plurality of text descriptions of the plurality of video materials. In addition, the apparatus 700 further includes a video material determination module 706 configured to determine, based on the plurality of segment texts of the audio and the plurality of text descriptions of the plurality of video materials, a video material matching with each of the plurality of segment texts.

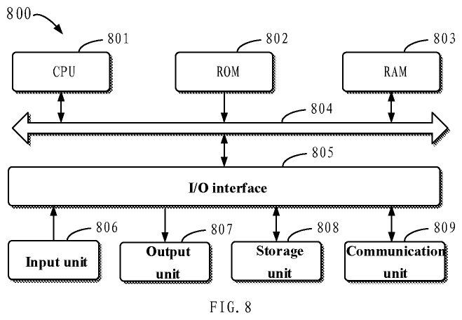

FIG. 8 shows a block diagram of an electronic device 800 according to some embodiments of the present disclosure, and the device 800 may be the device or apparatus described in the embodiments of the present disclosure. As shown in FIG. 8, the device 800 includes a central processing unit (CPU) and/or a graphics processing unit (GPU) 801, which may perform various appropriate actions and processing according to computer program instructions stored in a read-only memory (ROM) 802 or computer program instructions loaded from a storage unit 808 into a random access memory (RAM) 803. In the RAM 803, various programs and data required for the operation of the device 800 may also be stored. The CPU/GPU 801, the ROM 802, and the RAM 803 are connected to each other through a bus 804. An input/output (I/O) interface 805 is also connected to the bus 804. Although not shown in FIG. 8, the device 800 may further include a coprocessor.

A plurality of components in the device 800 are connected to the I/O interface 805, and the components include: an input unit 806, such as a keyboard, a mouse, etc.; an output unit 807, such as various types of displays, speakers, etc.; the storage unit 808, such as a magnetic disk, an optical disc, etc.; and a communication unit 809, such as a network card, a modem, a wireless communication transceiver, etc. The communication unit 809 allows the device 800 to exchange information/data with other devices through a computer network such as the Internet and/or various telecommunication networks.

The various methods or processes described above may be executed by the CPU/GPU 801. For example, in some embodiments, the method may be implemented as a computer software program, which is tangibly contained in a machine-readable medium, such as the storage unit 808. In some embodiments, a portion or an entirety of the computer program may be loaded and/or installed into the device 800 via the ROM 802 and/or the communication unit 809. When the computer program is loaded into the RAM 803 and executed by the CPU/GPU 801, one or more steps or actions in the method or process described above may be executed.

In some embodiments, the methods and processes described above may be implemented as a computer program product. The computer program product may include a computer-readable storage medium having computer-readable program instructions for performing various aspects of the present disclosure stored thereon.

The computer-readable storage medium may be a tangible device that may hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanically encoded device such as a punch card or a raised structure in a groove with instructions stored thereon, and any suitable combination of the above. The computer-readable storage medium used here is not interpreted as an instantaneous signal itself, such as a radio wave or other freely propagating electromagnetic waves, electromagnetic waves propagating through a waveguide or other transmission media (for example, light pulses through an optical fiber cable), or electrical signals transmitted through wires.

The computer-readable program instructions described herein may be downloaded from the computer-readable storage medium to various computing/processing devices, or downloaded to an external computer or an external storage device through a network, such as the Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, including object-oriented programming languages and conventional procedural programming languages. The computer-readable program instructions may be executed entirely on a user computer, partly on the user computer, as a stand-alone software package, partly on the user computer and partly on a remote computer, or entirely on the remote computer or a server. In the case of involving the remote computer, the remote computer may be connected to the user computer through any kind of network, including a local area network (LAN) or a wide area network (WAN), or it may be connected to an external computer (for example, connected by using Internet provided by an Internet service provider). In some embodiments, by using state information of the computer-readable program instructions to customize an electronic circuit, such as a programmable logic circuit, a field programmable gate array (FPGA), or a programmable logic array (PLA), the electronic circuit may execute the computer-readable program instructions, thereby implementing various aspects of the present disclosure.

These computer-readable program instructions may be provided to a processing unit of a general-purpose computer, a special-purpose computer, or other programmable data processing apparatus to produce a machine, so that these instructions, when executed by the processing unit of the computer or other programmable data processing apparatus, produce an apparatus for implementing a specific function/action in one or more blocks in the flowcharts and/or block diagrams. These computer-readable program instructions may also be stored in the computer-readable storage medium, and these instructions cause the computer, the programmable data processing apparatus, and/or other devices to work in a specific manner, so that the computer-readable medium storing the instructions includes a manufactured product, which includes instructions for implementing various aspects of the specific function/action in one or more blocks in the flowcharts and/or block diagrams.

The computer-readable program instructions may also be loaded onto the computer, other programmable data processing apparatus, or other devices, so that a series of operation steps are performed on the computer, other programmable data processing apparatus, or other devices to produce a computer-implemented process, thereby causing the instructions executed on the computer, other programmable data processing apparatus, or other devices to implement the specific function/action in one or more blocks in the flowcharts and/or block diagrams.

The flowcharts and block diagrams in the drawings show the possibly implemented architectures, functions, and operations of the device, the method, and the computer program product according to the embodiments of the present disclosure. In this regard, each block in the flowchart or block diagram may represent a module, program segment, or part of an instruction, and the module, program segment, or part of the instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and the combination of the blocks in the block diagrams and/or flowcharts may be implemented by a special-purpose hardware-based system that performs specified functions or actions, or may be implemented by a combination of special-purpose hardware and computer instructions.

The embodiments of the present disclosure have been described above, and the above description is exemplary, non-exhaustive, and not limited to the disclosed embodiments. Without departing from the scope and spirit of the illustrated embodiments, many modifications and changes will be apparent to those of ordinary skill in the art. The terms used herein are chosen to best explain the principles of the embodiments, the practical application or the technical improvement of the technology in the market, or to enable other those of ordinary skill in the art to understand the embodiments disclosed herein.

Some example implementations of the present disclosure are listed below.
Example 1. A method for matching video material, including:
   generating, based on understanding of content of an audio, a plurality of segment texts of the audio;
   generating, based on understanding of multimodal content of a plurality of video materials, a plurality of text descriptions of the plurality of video materials; and
   determining, based on the plurality of segment texts of the audio and the plurality of text descriptions of the plurality of video materials, a video material matching with each of the plurality of segment texts.
Example 2. The method of Example 1, where generating, based on the understanding of the content of the audio, the plurality of segment texts of the audio includes:
   generating, by a speech model based on the content of the audio, the plurality of segment texts of the audio and a plurality of speech texts corresponding to the plurality of segment texts.
Example 3. The method of any one of Examples 1-2, where generating, based on the understanding of the multimodal content of the plurality of video materials, the plurality of text descriptions of the plurality of video materials includes:
   generating, by a multimodal understanding model based on the multimodal content of the plurality of video materials, the plurality of text descriptions of the plurality of video materials, the multimodal content including speech content, image content, and highlight video content of the video materials.
Example 4. The method of any one of Examples 1-3, where determining, based on the plurality of segment texts of the audio and the plurality of text descriptions of the plurality of video materials, the video material matching with each of the plurality of segment texts includes:
   determining a plurality of matching degrees between each segment text and the plurality of text descriptions of the plurality of video materials; and
   determining, based on the plurality of matching degrees, a target video material matching with each segment text.
Example 5. The method of any one of Examples 1-4, where determining, based on the plurality of segment texts of the audio and the plurality of text descriptions of the plurality of video materials, the video material matching with each of the plurality of segment texts further includes:
   in response to a first segment text and a second segment text in the plurality of segment texts matching to a same video material, and the first segment text being before the second segment text, determining the same video material as a template video material matching with the first segment text which is temporally earlier.
Example 6. The method of any one of Examples 1-5, where determining, based on the plurality of segment texts of the audio and the plurality of text descriptions of the plurality of video materials, the video material matching with each of the plurality of segment texts further includes:
   generating, by the multimodal understanding model based on a time range of each segment text, a candidate video material corresponding to the time range of each segment text.
Example 7. The method of any one of Examples 1-6, further including:
   in response to a time duration of the target video material being shorter than a time duration of the segment text, filling the target video material with video material, the filling video material being determined based on the matching degree.
Example 8. The method of any one of Examples 1-7, further including:
   in response to detecting an upload of the audio, displaying the audio on an audio track;
   in response to detecting uploads of the plurality of video materials, displaying the plurality of uploaded video materials on a material display page; and
   displaying a button for material matching on the material display page.
Example 9. The method of any one of Examples 1-8, further including:
   in response to detecting a click of a user on the button, displaying the plurality of segment texts of the audio in sequence on a text track;
   displaying the candidate video material corresponding to each segment text in sequence on a main video track; and
   displaying the time range of each segment text, the text description of the candidate video material, and the matching degree between each segment text and the candidate video material.
Example 10. The method of any one of Examples 1-9, further including:
   in response to detecting the click of the user on the button, adding, to the candidate video material, a subtitle corresponding to each segment text, the subtitle being the speech text corresponding to each segment text.
Example 11. An apparatus for matching video material, including:
   a segment text generation module configured to generate, based on understanding of content of an audio, a plurality of segment texts of the audio;
   a text description generation module configured to generate, based on understanding of multimodal content of a plurality of video materials, a plurality of text descriptions of the plurality of video materials; and
   a video material determination module configured to determine, based on the plurality of segment texts of the audio and the plurality of text descriptions of the plurality of video materials, a video material matching with each of the plurality of segment texts.
Example 12. The apparatus of Example 11, where the segment text generation module includes:
   a first generation module configured to generate, by a speech model based on the content of the audio, the plurality of segment texts of the audio and a plurality of speech texts corresponding to the plurality of segment texts.
Example 13. The apparatus of any one of Examples 11-12, where the text description generation includes:
   a second generation module configured to generate, by a multimodal understanding model based on the multimodal content of the plurality of video materials, the plurality of text descriptions of the plurality of video materials, the multimodal content including speech content, image content, and highlight video content of the video material.
Example 14. The apparatus of any one of Examples 11-13, where the video material determination module includes:
   a matching degree determination module configured to determine a plurality of matching degrees between each segment text and the plurality of text descriptions of the plurality of video materials; and
   a target video material determination module configured to determine, based on the plurality of matching degrees, a target video material matching with each segment text.
Example 15. The apparatus of any one of Examples 11-14, where the video material determination module further includes:
   a template video material determination module configured to: in response to a first segment text and a second segment text in the plurality of segment texts matching to a same video material, and the first segment text being before the second segment text, determine the same video material as a template video material matching with the first segment text which is temporally earlier.
Example 16. The apparatus of any one of Examples 11-15, where the template video material further includes:
   a candidate video material determination module configured to generate, by the multimodal understanding model based on a time range of each segment text, a candidate video material corresponding to the time range of each segment text.
Example 17. The apparatus of any one of Examples 11-16, further including:
   a filling module configured to: in response to a time duration of the target video material being shorter than a time duration of the segment text, fill the target video material with video material, the filling video material being determined based on the matching degree.
Example 18. The apparatus of any one of Examples 11-17, further including:
   a first display module configured to: in response to detecting an upload of the audio, display the audio on an audio track;
   a second display module configured to: in response to detecting uploads of the plurality of video materials, display the plurality of uploaded video materials on a material display page; and
   a third display module configured to display a button for material matching on the material display page.
Example 19. The apparatus of any one of Examples 11-18, further including:
   a fourth display module configured to: in response to detecting a click of a user on the button, display the plurality of segment texts of the audio in sequence on a text track;
   a fifth display module configured to display the candidate video material corresponding to each segment text in sequence on a main video track; and
   a sixth display module configured to display the time range of each segment text, the text description of the candidate video material, and the matching degree between each segment text and the candidate video material.
Example 20. The apparatus of any one of Examples 11-19, further including:
   a seventh display module configured to: in response to detecting the click of the user on the button, add, to the candidate video material, a subtitle corresponding to each segment text, the subtitle being the speech text corresponding to each segment text.
Example 21. An electronic device, including:
   a processor; and
   a memory coupled with the processor, the memory having instructions stored therein, the instructions, when executed by the processor, causing the electronic device to perform actions, the actions including:
   generating, based on understanding of content of an audio, a plurality of segment texts of the audio;
   generating, based on understanding of multimodal content of a plurality of video materials, a plurality of text descriptions of the plurality of video materials; and
   determining, based on the plurality of segment texts of the audio and the plurality of text descriptions of the plurality of video materials, a video material matching with each of the plurality of segment texts.
Example 22. The electronic device of Example 21, where generating, based on the understanding of the content of the audio, the plurality of segment texts of the audio includes:
   generating, by a speech model based on the content of the audio, the plurality of segment texts of the audio and a plurality of speech texts corresponding to the plurality of segment texts.
Example 23. The electronic device of any one of Examples 21-22, where generating, based on the understanding of multimodal content of the plurality of video materials, the plurality of text descriptions of the plurality of video materials includes:
   generating, by a multimodal understanding model based on the multimodal content of the plurality of video materials, the plurality of text descriptions of the plurality of video materials, the multimodal content including speech content, image content, and highlight video content of the video materials.
Example 24. The electronic device of any one of Examples 21-23, where determining, based on the plurality of segment texts of the audio and the plurality of text descriptions of the plurality of video materials, the video material matching with each of the plurality of segment texts includes:
   determining a plurality of matching degrees between each segment text and the plurality of text descriptions of the plurality of video materials; and
   determining, based on the plurality of matching degrees, a target video material matching with each segment text.
Example 25. The electronic device of any one of Examples 21-24, where determining, based on the plurality of segment texts of the audio and the plurality of text descriptions of the plurality of video materials, the video material matching with each of the plurality of segment texts further includes:
   in response to a first segment text and a second segment text in the plurality of segment texts matching to a same video material, and the first segment text being before the second segment text, determining the same video material as a template video material matching with the first segment text which is temporally earlier.
Example 26. The electronic device of any one of Examples 21-25, where determining, based on the plurality of segment texts of the audio and the plurality of text descriptions of the plurality of video materials, the video material matching with each of the plurality of segment texts further includes:
   generating, by the multimodal understanding model based on a time range of each segment text, a candidate video material corresponding to the time range of each segment text.
Example 27. The electronic device of any one of Examples 21-26, further including:
   in response to a time duration of the target video material being shorter than a time duration of the segment text, filling the target video material with video material, the filling video material being determined based on the matching degree.
Example 28. The electronic device of any one of Examples 21-27, further including:
   in response to detecting an upload of the audio, displaying the audio on the audio track;
   in response to detecting uploads of the plurality of video materials, displaying the plurality of uploaded video materials on a material display page; and
   displaying a button for material matching on the material display page.
Example 29. The electronic device of any one of Examples 21-28, further including:
   in response to detecting a click of a user on the button, displaying the plurality of segment texts of the audio in sequence on a text track;
   displaying the candidate video material corresponding to each segment text in sequence on a main video track; and
   displaying the time range of each segment text, the text description of the candidate video material, and the matching degree between each segment text and the candidate video material.
Example 30. The electronic device of any one of Examples 21-29, further including:
   in response to detecting the click of the user on the button, adding, to the candidate video material, a subtitle corresponding to each segment text, the subtitle being the speech text corresponding to each segment text.

Example 31. A computer-readable storage medium having stored thereon computer-executable instructions, where the computer-executable instructions are executed by a processor to implement the method of any one of Examples 1-10.

Example 32. A computer program product tangibly stored on a computer-readable medium and including computer-executable instructions that, when executed by a device, cause the device to perform the method of any one of Examples 1-10.

Although the present disclosure has been described in language specific to structural features and/or logical actions of the method, it should be understood that the subject matter defined in the appended claims is not necessarily limited to the specific features or actions described above. Rather, the specific features and actions described above are merely example forms for implementing the claims.

1. A method for matching video, comprising:
generating, based on understanding of content of an audio, a plurality of segment texts of the audio;
generating, based on understanding of multimodal content of a plurality of videos, a plurality of text descriptions of the plurality of videos; and
determining, based on the plurality of segment texts of the audio and the plurality of text descriptions of the plurality of videos, a video matching with at least one of the plurality of segment texts.

2. The method of claim 1, wherein generating, based on the understanding of the content of the audio, the plurality of segment texts of the audio comprises:
generating, by a speech model based on the content of the audio, the plurality of segment texts of the audio and a plurality of speech texts corresponding to the plurality of segment texts.

3. The method of claim 1, wherein generating, based on the understanding of the multimodal content of the plurality of videos, the plurality of text descriptions of the plurality of videos comprises:
generating, by a multimodal understanding model based on the multimodal content of the plurality of videos, the plurality of text descriptions of the plurality of videos, the multimodal content comprising speech content, image content, and highlight video content of the videos.

4. The method of claim 1, wherein determining, based on the plurality of segment texts of the audio and the plurality of text descriptions of the plurality of videos, the video matching with the at least one of the plurality of segment texts comprises:
determining a plurality of matching degrees between the at least one segment text and the plurality of text descriptions of the plurality of videos; and
determining, based on the plurality of matching degrees, a first video matching with the at least one segment text.

5. The method of claim 4, wherein determining, based on the plurality of segment texts of the audio and the plurality of text descriptions of the plurality of videos, the video matching with the at least one of the plurality of segment texts further comprises:
in response to a first segment text and a second segment text in the plurality of segment texts matching to a same video, and the first segment text being before the second segment text, determining the same video as a template video matching with the first segment text which is temporally earlier.

6. The method of claim 5, wherein determining, based on the plurality of segment texts of the audio and the plurality of text descriptions of the plurality of videos, the video matching with the at least one of the plurality of segment texts further comprises:
generating, by the multimodal understanding model based on a time range of the at least one segment text, a candidate video corresponding to the time range of the at least one segment text.

7. The method of claim 6, further comprising:
in response to a time duration of the first video being shorter than a time duration of the segment text, filling the first video with video, the filling video being determined based on the matching degree.

8. The method of claim 6, further comprising:
in response to detecting an upload of the audio, displaying the audio on an audio track;
in response to detecting uploads of the plurality of videos, displaying the plurality of uploaded videos on a material display page; and
displaying a control for material matching on the material display page.

9. The method of claim 8, further comprising:
in response to detecting a click of a user on the control, displaying the plurality of segment texts of the audio in sequence on a text track;
displaying the candidate video corresponding to the at least one segment text in sequence on a main video track; and
displaying the time range of the at least one segment text, the text description of the candidate video, and the matching degree between the at least one segment text and the candidate video.

10. The method of claim 9, further comprising:
in response to detecting the click of the user on the control, adding, to the candidate video, a subtitle corresponding to the at least one segment text, the subtitle being a speech text corresponding to the at least one segment text.

11. An electronic device, comprising:
a processor; and
a memory coupled with the processor, the memory having instructions stored therein, the instructions, when executed by the processor, causing the electronic device to:
generate, based on understanding of content of an audio, a plurality of segment texts of the audio;
generate, based on understanding of multimodal content of a plurality of videos, a plurality of text descriptions of the plurality of videos; and
determine, based on the plurality of segment texts of the audio and the plurality of text descriptions of the plurality of videos, a video matching with at least one of the plurality of segment texts.

12. The electronic device of claim 11, wherein the instructions causing the processor to generate, based on the understanding of the content of the audio, the plurality of segment texts of the audio comprise instructions causing the processor to:
generate, by a speech model based on the content of the audio, the plurality of segment texts of the audio and a plurality of speech texts corresponding to the plurality of segment texts.

13. The electronic device of claim 11, wherein the instructions causing the processor to generate, based on the understanding of the multimodal content of the plurality of videos, the plurality of text descriptions of the plurality of videos comprise instructions causing the processor to:
generate, by a multimodal understanding model based on the multimodal content of the plurality of videos, the plurality of text descriptions of the plurality of videos, the multimodal content comprising speech content, image content, and highlight video content of the videos.

14. The electronic device of claim 11, wherein the instructions causing the processor to determine, based on the plurality of segment texts of the audio and the plurality of text descriptions of the plurality of videos, the video matching with the at least one of the plurality of segment texts comprise instructions causing the processor to:
determine a plurality of matching degrees between the at least one of the plurality of segment text and the plurality of text descriptions of the plurality of videos; and
determine, based on the plurality of matching degrees, a first video matching with the at least one segment text.

15. The electronic device of claim 14, wherein the instructions causing the processor to determine, based on the plurality of segment texts of the audio and the plurality of text descriptions of the plurality of videos, the video matching with the at least one of the plurality of segment texts further comprise instructions causing the processor to:
in response to a first segment text and a second segment text in the plurality of segment texts matching to a same video, and the first segment text being before the second segment text, determine the same video as a template video matching with the first segment text which is temporally earlier.

16. The electronic device of claim 15, wherein the instructions causing the processor to determine, based on the plurality of segment texts of the audio and the plurality of text descriptions of the plurality of videos, the video matching with the at least one of the plurality of segment texts further comprise instructions causing the processor to:
generate, by the multimodal understanding model based on a time range of the at least one segment text, a candidate video corresponding to the time range of the at least one segment text.

17. The electronic device of claim 16, further comprising instructions causing the processor to:
in response to a time duration of the first video being shorter than a time duration of the segment text, fill the first video with video, the filling video being determined based on the matching degree.

18. The electronic device of claim 16, further comprising instructions causing the processor to:
in response to detecting an upload of the audio, display the audio on an audio track;
in response to detecting uploads of the plurality of videos, display the plurality of uploaded videos on a material display page; and
display a control for material matching on the material display page.

19. The electronic device of claim 19, further comprising instructions causing the processor to:
in response to detecting a click of a user on the control, display the plurality of segment texts of the audio in sequence on a text track;
display the candidate video corresponding to the at least one segment text in sequence on a main video track; and
display the time range of the at least one segment text, the text description of the candidate video, and the matching degree between the at least one segment text and the candidate video.

20. A computer program product comprising a non-transitory computer-readable storage medium having computer-executable instructions, wherein the computer-executable instructions are executed by a processor to:
generate, based on understanding of content of an audio, a plurality of segment texts of the audio;
generate, based on understanding of multimodal content of a plurality of videos, a plurality of text descriptions of the plurality of videos; and
determine, based on the plurality of segment texts of the audio and the plurality of text descriptions of the plurality of videos, a video matching with at least one of the plurality of segment texts.
